(19) United States
(12) Patent Application Publication
(10) Pub. No.: US 2024/0156087 A1
(43) Pub. Date: May 16, 2024

(54) Organic Plant Growth Compound System

(71) Applicant: Steve Moseley, Paris, TN (US)

(72) Inventor: Steve Moseley, Paris, TN (US)

(21) Appl. No.: 18/322,280

(22) Filed: May 23, 2023

Related U.S. Application Data
(63) Continuation of application No. 18/187,067, filed on Mar. 21, 2023.
(60) Provisional application No. 63/425,341, filed on Nov. 15, 2022.

(51) Int. Cl. A01N 33/04; A01N 37/06; A01N 41/04; A01N 43/08; A01N 43/16; A01N 57/10; A01N 65/20; A01N 65/36

(52) U.S. Cl. CPC A01N 33/04; A01N 37/06; A01N 41/04; A01N 43/08; A01N 43/16; A01N 57/10; A01N 65/20; A01N 65/36

(57) ABSTRACT

A plant growth compound system comprised of a compound that can be sprayed on agriculture crops in foliar application and/or applied to agricultural soil is disclosed. The compound improves plant growth. The system is also comprised of a method of making the compound. The ingredients in the compound are comprised of (but not limited to) organic sugar cane alcohol, oleic acid, organic sunflower lecithin surfactant, water, gluconic acid, pre-dissolved sea salt, fulvic acid, pre-dissolved lecithin, soy oil, canola oil, pre-dissolved alfalfa (preferably in powder form) and molasses.

### CROSS-REFERENCE TO RELATED APPLICATION

The present application is a continuation in part of, and claims priority to and the benefit of, U.S. patent application Ser. No. 18/187,067 which was filed on Mar. 21, 2023. and claims priority from U.S. Provisional Application No. 63/425,341, which was filed on Nov. 15, 2022, both of which are incorporated herein by reference in their entirety.

### FIELD OF THE INVENTION

The present invention relates generally to the field of organic plant growth compounds. More specifically, the present invention relates to an organic plant growth compound system comprised of an organic compound that can be sprayed on agriculture crops in foliar application and/or applied to agricultural soil to improve plant growth and a method of making the compound. The ingredients in the compound are comprised of (but not limited to), organic sugar cane alcohol, oleic acid, organic sunflower lecithin surfactant, water, gluconic acid, pre-dissolved sea salt, fulvic acid, pre-dissolved lecithin, soy oil, canola oil, pre-dissolved alfalfa (preferably in powder form) and molasses. Accordingly, the present disclosure makes specific reference thereto. Nonetheless, it is to be appreciated that aspects of the present invention are also equally applicable to other like applications, devices, and methods of manufacture.

### BACKGROUND

Farmers, homeowners, gardeners, etc., may be looking for ways to improve plant growth. In an attempt to improve plant growth, individuals may add growing products to their plants. These products may protect plants against disease, insects, and drought. However, some growing products can be harmful to the environment despite improving plant growth.

Therefore, there exists a long-felt need in the art for an improved plant growth compound. There also exists a long-felt need in the art for a plant growth compound system that provides a natural plant bio-stimulant that increases root growth, plant health, and helps a plant achieve a higher productivity level. In addition, there exists a long-felt need in the art for a plant growth compound system that enhances production of agricultural crops, grasses, and flowers by improving the soil's ability to be more productive. Further, there exists a long-felt need in the art for a plant growth compound system that is comprised of a compound that can be easily spread onto plants and soil.

The subject matter disclosed and claimed herein, in one embodiment thereof, comprises a plant growth compound system. The system is comprised of a compound comprised of a plurality of ingredients. The compound can be sprayed on agriculture crops in foliar application and/or applied to agricultural soil to improve plant growth. The ingredients in the compound are comprised of (but not limited to) organic sugar cane alcohol, oleic acid, organic sunflower lecithin surfactant, water, gluconic acid, pre-dissolved sea salt, fulvic acid, pre-dissolved lecithin, soy oil, canola oil, pre-dissolved alfalfa (preferably in powder form) and molasses. The system is also comprised of a sequential method of making the compound.

In this manner, the plant growth compound system of the present invention accomplishes all the foregoing objectives and provides an improved plant growth compound. The plant growth compound system provides a natural plant bio-stimulant that increases root growth, plant health, and helps a plant achieve a higher productivity level. In addition, the compound enhances production of agricultural crops, grasses, and flowers by improving the soil's ability to be more productive. Finally, the compound can be easily spread onto plants and soil.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a plant growth compound system. The system is comprised of a compound comprised of a plurality of ingredients. The compound can be sprayed on agriculture crops in foliar application and/or applied to agricultural soil. The ingredients in the compound are comprised of (but not limited to), organic sugar cane alcohol, oleic acid, organic sunflower lecithin surfactant, water, gluconic acid, pre-dissolved sea salt, fulvic acid, pre-dissolved lecithin, soy oil, canola oil, pre-dissolved alfalfa (preferably in powder form) and molasses.

The ingredients of the compound are preferably (but not limited to) in the following proportions: 60 gallons of organic sugar cane alcohol, 120 gallons of oleic acid, 55 gallons of organic sunflower lecithin surfactant, 231 gallons of water, 60 gallons of gluconic acid, 50 pounds of pre-dissolved sea salt, 3 pounds of fulvic acid, 10 pounds of pre-dissolved lecithin, 10 gallons of soy oil, 27.5 gallons of canola oil, 3 pounds of pre-dissolved alfalfa and 15 gallons of molasses. This combination of ingredients yields 650 gallons of the compound.

The system is also comprised of a method of making the compound in a sequential process. First, 60 gallons of organic sugar cane alcohol and 120 gallons of oleic acid are mixed with constant stirring for three hours. Then after three hours of constant stirring, 55 gallons of organic sunflower lecithin surfactant is mixed with 55 gallons of water with constant stirring for two hours. After the two hours, 60 gallons of gluconic acid is added and mixed for one hour. After the one hour, 50 pounds of sea salt (that has been dissolved for 24 hours) is mixed with 20 gallons of water and three pounds of fulvic acid for one hour. Next, after the one hour, 10 pounds of lecithin (that has been dissolved for 24 hours) is added with 20 gallons of water and are mixed for one hour. After the one hour, 10 gallons of soy oil, and 27.5 gallons of canola oil are mixed for one hour. Next, after the one hour, 3 pounds of alfalfa (that has been dissolved for 24 hours) and 15 gallons of water are added. Finally, 15 gallons of molasses is slow mixed with 156 gallons of water for eight hours at ambient temperature.

Accordingly, the plant growth compound system of the present invention is particularly advantageous as it provides an improved plant growth compound in the form of a plant growth compound system. The compound of the system provides a natural plant bio-stimulant that increases root growth, plant health, and helps a plant achieve a higher productivity level using natural ingredients. In addition, the compound enhances production of agricultural crops, grasses, and flowers by improving soil's ability to be more productive. Finally, the compound can be easily spread onto plants and soil. In this manner, the plant growth compound system overcomes the limitations of existing plant growth compounds known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of ingredients of one potential embodiment of a plant growth compound system of the present invention in accordance with the disclosed architecture;

FIG. 2 illustrates a flowchart of a method of making one potential embodiment of a plant growth compound of the present invention in accordance with the disclosed architecture; and

FIG. 3 illustrates a flowchart of a method of making another potential embodiment of a plant growth compound of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved plant growth compound. There also exists a long-felt need in the art for a plant growth compound system that provides a natural plant bio-stimulant that increases root growth, plant health, and helps a plant achieve a higher productivity level. In addition, there exists a long-felt need in the art for a plant growth compound system that enhances production of agricultural crops, grasses, and flowers by improving the soil's ability to be more productive. Further, there exists a long-felt need in the art for a plant growth compound system that is comprised of a compound that can be easily spread onto plants and soil.

The present invention, in one exemplary embodiment, is comprised of a plant growth compound system comprised of a compound and a method of making the compound. The compound can be sprayed on agriculture crops in foliar application and/or applied to agricultural soil. The ingredients in the compound are comprised of (but not limited to) organic sugar cane alcohol, oleic acid, organic sunflower lecithin surfactant, water, gluconic acid, pre-dissolved sea salt, fulvic acid, pre-dissolved lecithin, soy oil, canola oil, pre-dissolved alfalfa (preferably in powder form) and molasses.

The ingredients of the compound are preferably (but not limited to) in the following proportions: 60 gallons of organic sugar cane alcohol, 120 gallons of oleic acid, 55 gallons of organic sunflower lecithin surfactant, 231 gallons of water, 60 gallons of gluconic acid, 50 pounds of pre-dissolved sea salt, 3 pounds of fulvic acid, 10 pounds of pre-dissolved lecithin, 10 gallons of soy oil, 27.5 gallons of canola oil, 3 pounds of pre-dissolved alfalfa and 15 gallons of molasses. This combination of ingredients yields 650 gallons of the compound.

The system is also comprised of a method of making the compound in a sequential process. First, 60 gallons of organic sugar cane alcohol and 120 gallons of oleic acid are mixed with constant stirring for three hours. Then after three hours of constant stirring, 55 gallons of organic sunflower lecithin surfactant is mixed with 55 gallons of water with constant stirring for two hours. After the two hours, 60 gallons of gluconic acid is added and mixed for one hour. After the one hour, 50 pounds of sea salt (that has been dissolved for 24 hours) is mixed with 20 gallons of water and three pounds of fulvic acid for one hour. Next, after the one hour, 10 pounds of lecithin (that has been dissolved for 24 hours) is added with 20 gallons of water and is mixed for one hour. After the one hour, 10 gallons of soy oil, and 27.5 gallons of canola oil are mixed for one hour. Next, after the one hour, 3 pounds of alfalfa (that has been dissolved for 24 hours) and 15 gallons of water are added. Finally, 15 gallons of molasses is slow mixed with 156 gallons of water for eight hours at ambient temperature.

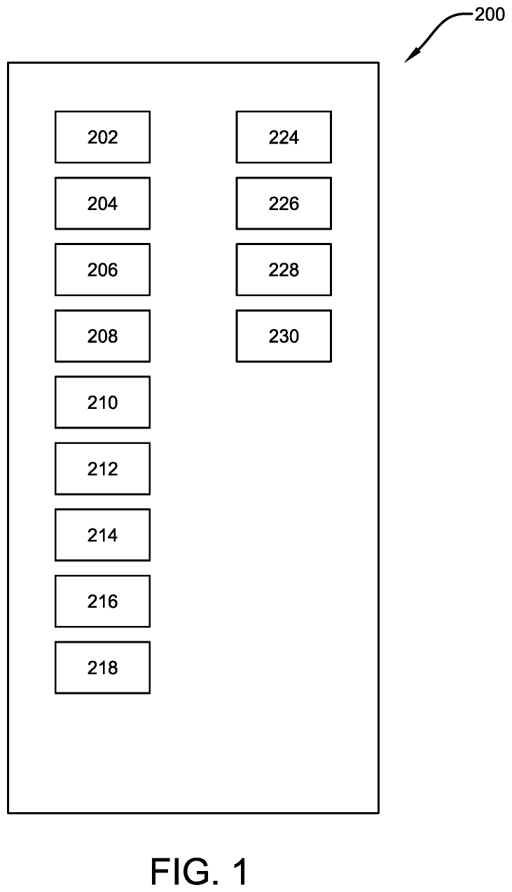

Referring initially to the drawings, FIG. 1 illustrates a graphical view of ingredients of one potential embodiment of a plant growth compound system 100 of the present invention in accordance with the disclosed architecture. The compound 200 is comprised of a plurality of ingredients. Each ingredient in the compound 200 enhances the microbial action of the compound 200. The compound 200 can be sprayed on agriculture crops in foliar application and/or applied to agricultural soil. The ingredients in the compound 200 are comprised of (but not limited to) organic sugar cane alcohol 204, oleic acid 206, organic sunflower lecithin surfactant 208, water 210, gluconic acid 212, pre-dissolved sea salt 214, fulvic acid 216, pre-dissolved lecithin 218, soy oil 224, canola oil 226, pre-dissolved alfalfa 228 (preferably in powder form) and molasses 230.

The organic sugar cane alcohol 204 is used to decrease the surface tension of the compound 200 when applied to a plant and allow the compound 200 to be more easily absorbed by the plant. The gluconic acid 212 balances the mixture between the cation-anion balance on the electrolyte solution of the compound 200. The sea salt 214 serves as a wide spectrum mineral product for plant food. The sea salt 214 is pre-dissolved to ensure it is completely dissolved within the compound 200. The fulvic acid 216 is used to increase the mineral and water uptake to the plant from soil. The acid 216 also aids the compound 200 when foliar feeding plants over the top. The lecithin 218 serves as a surfactant and is used to mix the oil-based ingredients. The omega 6 fatty acids of the soy oil 224 is used as a plant food source. The canola oil 226 is used as a source of brassica steroids. The alfalfa 228 provides B-vitamins for plant growth, structure, and health. Finally, molasses 230 is used to increase plant/soil health and synergy.

The ingredients of the compound 200 are preferably (but not limited to) in the following proportions: 60 gallons of organic sugar cane alcohol 204, 120 gallons of oleic acid 206, 55 gallons of organic sunflower lecithin surfactant 208, 231 gallons of water 210, 60 gallons of gluconic acid 212, 50 pounds of pre-dissolved sea salt 214, 3 pounds of fulvic acid 216, 10 pounds of pre-dissolved lecithin 218, 10 gallons of soy oil 224, 27.5 gallons of canola oil 226, 3 pounds of pre-dissolved alfalfa 228 and 15 gallons of molasses 230. This combination of ingredients yields 650 gallons of the compound 200. However, the compound 200 and ingredients may be in different proportions/combinations/amounts to yield different amounts and/or concentrations of the compound 200.

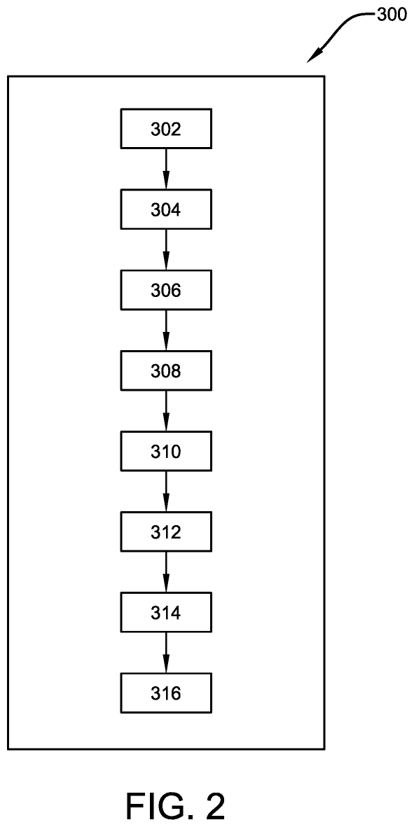

FIG. 2 illustrates a flowchart of a method of making 300 one potential embodiment of a plant growth compound of the present invention in accordance with the disclosed architecture. The system is also comprised of a method 300 of making the compound 200 in a sequential process. First, 60 gallons of organic sugar cane alcohol and 120 gallons of oleic acid are mixed with constant stirring for three hours [Step 302]. Then after three hours of constant stirring, 55 gallons of organic sunflower lecithin surfactant is mixed with 55 gallons of water with constant stirring for two hours [Step 304]. After the two hours, 60 gallons of gluconic acid is added and mixed for one hour [Step 306]. After the one hour, 50 pounds of sea salt (that has been dissolved for 24 hours) is mixed with 20 gallons of water and three pounds of fulvic acid for one hour [Step 308]. Next, after the one hour, 10 pounds of lecithin (that has been dissolved for 24 hours) is added with 20 gallons of water and are mixed for one hour [Step 310]. After the one hour, 10 gallons of soy oil and 27.5 gallons of canola oil are mixed for one hour [Step 312]. Next, after the one hour, 3 pounds of alfalfa (that has been dissolved for 24 hours) and 15 gallons of water are added [Step 314]. Finally, 15 gallons of molasses is slow mixed with 156 gallons of water for eight hours at ambient temperature [Step 316].

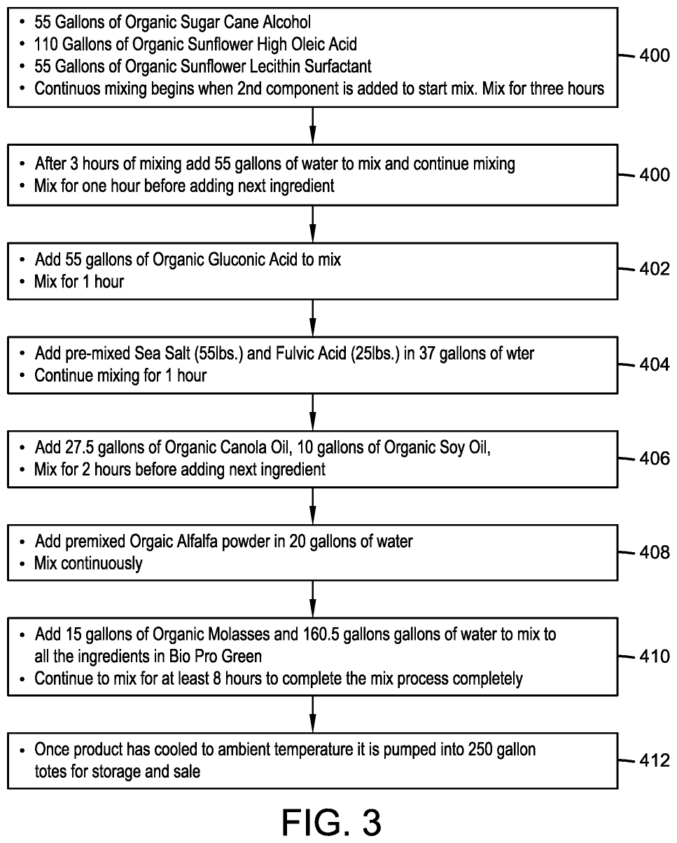

FIG. 3 illustrates a flowchart of a method of making another potential embodiment of a plant growth compound of the present invention in accordance with the disclosed architecture. First, 55 gallons of organic sugar cane alcohol, 110 gallons of organic sunflower high oleic acid and 55 gallons of organic sunflower lecithin surfactant are mixed with constant stirring for three hours [Step 400]. The mixing begins when the second component is added.

Then, after three hours of constant stirring, 55 gallons of water is added to the mix with constant stirring for one hours [Step 402]. After the one hour, 55 gallons of gluconic acid is added and mixed for one hour [Step 403]. After the one hour, a premix comprised of 55 pounds of sea salt is mixed with 37 gallons of water and 25 pounds of fulvic acid for one hour [Step 404].

Next, after the one hour, 27.5 gallons of organic canola oil is mixed with 10 gallons of organic soy oil for two hours before adding the next ingredient [Step 406]. After the two hours, premixed organic alfalfa powder is added along with 20 gallons of water [Step 408] and mixed continuously.

Then, 15 gallons of organic molasses and 160.5 gallons of water are added to the mix and the same is mixed for at least 8 hours [Step 410]. Finally, the resulting mixture is cooled to ambient temperature and pumped into 250 gallon totes for storage and sale [Step 412].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plant growth compound system” and “device” are interchangeable and refer to the plant growth compound system 100 of the present invention.

Notwithstanding the foregoing, the plant growth compound system 100 of the present invention and its various components can be of any suitable size and configuration as is known in the art without affecting the overall concept of the invention, provided that they accomplish the above-stated objectives. One of ordinary skill in the art will appreciate that the size, configuration, and material of the plant growth compound system 100 as shown in the FIGS. are for illustrative purposes only, and that many other sizes and shapes of the plant growth compound system 100 are well within the scope of the present disclosure. Although the dimensions of the plant growth compound system 100 are important design parameters for user convenience, the plant growth compound system 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plant growth compound comprising:
a organic sugar cane alcohol;
an oleic acid;
a organic sunflower lecithin surfactant;
a water;
a gluconic acid;
a sea salt;
a lecithin;
a soy oil;
a canola oil;
an alfalfa; and
a molasses.

2. The plant growth compound system of claim 1, wherein the organic sugar cane alcohol is comprised of 60 gallons of the organic sugar cane alcohol.

3. The plant growth compound system of claim 1, wherein the oleic acid is comprised of 120 gallons of the oleic acid.

4. The plant growth compound system of claim 1, wherein the organic sunflower lecithin surfactant is comprised of 55 gallons of the organic sunflower lecithin surfactant.

5. The plant growth compound system of claim 1, wherein the water is comprised of 231 gallons of the water.

6. The plant growth compound system of claim 1, wherein the gluconic acid is comprised of 60 gallons of the gluconic acid.

7. The plant growth compound system of claim 1, wherein the sea salt is comprised of 50 pounds of the sea salt.

8. The plant growth compound system of claim 1, wherein the fulvic acid is comprised of 3 pounds of the fulvic acid.

9. The plant growth compound system of claim 1, wherein the lecithin is comprised of 10 pounds of the lecithin.

10. The plant growth compound system of claim 1, wherein the soy oil is comprised of 10 gallons of the soy oil.

11. The plant growth compound system of claim 1, wherein the canola oil is comprised of 27.5 gallons of the canola oil.

12. The plant growth compound system of claim 1, wherein the alfalfa is comprised of 3 pounds of the alfalfa.

13. The plant growth compound system of claim 1, wherein the molasses is comprised of 15 gallons of the molasses.

14. A method of making a plant growth compound, the method comprising the steps of:
stirring an organic sugar cane alcohol and an oleic acid for a period of three hours;
adding an organic sunflower lecithin surfactant and a first quantity of water and stirring for an additional two hours;
adding a gluconic acid and stirring for an additional one hour;
adding a pre-dissolved sea salt, a second quantity of water, and a fulvic acid and stirring for an additional hour;
adding a pre-dissolved lecithin, a third quantity of water, and stirring for an additional one hour;
adding a soy oil, and a canola oil and stirring for an additional one hour;
adding a pre-dissolved alfalfa and a fourth quantity of water; and
adding and stirring a molasses and a fifth quantity of water for an eight-hour period.

15. The method of claim 14, wherein the molasses and the fifth quantity of water is stirred at an ambient temperature.

16. A method of making a plant growth compound, the method comprising the steps of:
stirring continuously a organic sugar cane alcohol, and an oleic acid for a period of three hours;
adding a organic sunflower lecithin surfactant and a first quantity of water and constantly stirring for an additional two hours;
adding a gluconic acid and stirring for an additional one hour;
pre-dissolving a sea salt for a 24-hour period;
adding the pre-dissolved sea salt, a second quantity of water, and a fulvic acid and stirring for an additional hour;
pre-dissolving a lecithin for a 24-hour period;
adding the pre-dissolved lecithin, a third quantity of water, and stirring for an additional one hour;
adding a soy oil, and a canola oil and stirring for an additional one hour;
pre-dissolving an alfalfa for a 24-hour period;
adding the pre-dissolved alfalfa and a fourth quantity of water; and
adding and stirring a molasses and a fifth quantity of water for an eight-hour period.

17. The plant growth compound system of claim 16, wherein the lecithin is comprised of 10 pounds of the lecithin.

18. The plant growth compound system of claim 17, wherein the soy oil is comprised of 10 gallons of the soy oil.

19. The plant growth compound system of claim 18, wherein the canola oil is comprised of 27.5 gallons of the canola oil.

20. The plant growth compound system of claim 19, wherein the alfalfa is comprised of 3 pounds of the alfalfa.
